(19) United States
(12) Patent Application Publication
(10) Pub. No.: US 2016/0237614 A1
(43) Pub. Date: Aug. 18, 2016

(54) FLUORINE-CONTAINING POLYMER AND TREATMENT AGENT

(71) Applicant: DAIKIN INDUSTRIES, LTD., Osaka-shi, Osaka (JP)

(72) Inventors: Rumi Kawabe, Settsu-shi, Osaka (JP); Ryousuke Hara, Settsu-shi, Osaka (JP); Kyouhei Sawaki, Settsu-shi, Osaka (JP); Ikuo Yamamoto, Settsu-shi, Osaka (JP)

(73) Assignee: DAIKIN INDUSTRIES, LTD., Osaka-shi, Osaka (JP)

(21) Appl. No.: 15/031,104

(22) PCT Filed: Oct. 22, 2014
(86) PCT No.: PCT/JP2014/078112

§ 371 Date: Apr. 21, 2016

(30) Foreign Application Priority Data
Oct. 23, 2013 (JP) 2013-220384

(51) Int. Cl. D06M 15/277; C09D 133/16

(52) U.S. Cl. CPC D06M 15/277; C09D 133/16; D06M 2200/01; D06M 2200/11; D06M 2200/12

(57) ABSTRACT

A fluorine-containing polymer including: (a) a repeat unit in which the α-position is an acrylate ester monomer substituted with a monovalent organic group or a halogen atom and which is derived from a fluorine-containing monomer having a fluoroalkyl group; (b) a repeat unit which is an alkyl acrylate having a C₆₋₁₃ alkyl group and is derived from a non-fluorine monomer; and (c) a repeat unit derived from a non-fluorine (meth)acrylate monomer having a cyclic hydrocarbon group. Also disclosed is a surface treatment agent containing the fluorine-containing polymer, a method of treating a substrate with the surface treatment agent and a treated substrate.

### TECHNICAL FIELD

The present invention relates to a fluorine-containing polymer, and a treatment agent which comprises the fluorine-containing polymer. The treatment agent of the present invention is excellent in water- and oil-repellency, and especially, the durability of water- and oil-repellency.

### BACKGROUND ART

Conventionally, various surface treatment agents comprising fluorine-containing polymers are proposed in, for example, WO 2002/083809 (Patent Document 1), WO 2009/008512 (Patent Document 2), and WO 2004/096939 (Patent Document 3). Patent Document 1 and Patent Document 2 disclose water- and oil-repellent compositions which comprise fluorine-containing polymers comprising (meth)acrylate monomers having an alkyl group having 15 or more carbon atoms, such as stearyl acrylate.

However, the water- and oil-repellent compositions in Patent Document 1 and Patent Document 2 had insufficient water- and oil-repellency, and especially insufficient durability of water- and oil-repellency.

A treatment bath of a water- and oil-repellent agent prepared by diluting a conventional general aqueous dispersion liquid often gives troubles, such as a roll soil resulting in a fabric soil, wherein a dispersion liquid breaks by a mechanical impact received when a fabric to be treated enters, emulsion particles are aggregated and sedimentated and then the polymer adheres to a repellent roll. As to the problem of adhesion of the polymer to the roll, the more the tackiness of polymer is, the more easily the problem arises.

### PRIOR ARTS DOCUMENTS

### Patent Documents

Patent Document 1: WO 2002/083809

Patent Document 2: WO 2009/008512

Patent Document 3 WO 2004/096939

### DISCLOSURE OF THE INVENTION

### Problems to be Solved by the Invention

An object of the present invention is to provide a treatment agent (particularly a surface treatment agent) which imparts excellent water- and oil-repellency, excellent soil resistance and excellent soil releasability to substrates such as textiles.

### Means for Solving the Problems

In order to solve this problem, the present inventors reached the following invention. The present invention provides a fluorine-containing polymer comprising:

(a) repeating units derived from a fluorine-containing monomer having a fluoroalkyl group which is an acrylate ester monomer substituted at α-position with a monovalent organic group or a halogen atom,

(b) repeating units derived from a fluorine-free monomer which is alkyl acrylate having an alkyl group having 6-13 carbon atoms, and

(c) repeating units derived from a fluorine-free (meth)acrylate monomer having a cyclic hydrocarbon group.

### Effects of the Invention

The present invention can provide excellent water repellency, oil repellency, soil resistance and soil releasability, especially excellent durability of water- and oil-repellency. The treatment agent of the present invention gives excellent properties (for example, water- and oil-repellency), even if the fluorine-containing polymer in the treatment agent has a low concentration. The treatment agent of the present invention has excellent stability of the treatment agent, for example, processing stability, and concomitant use stability with other agents, and gives excellent repellency, for example, the strong water repellency, under severe conditions. Even if the treated substrate is rubbed, the substrate has the high properties (for example, water- and oil-repellency), and has a high abrasion resistance. The treatment agent of the present invention is excellent in the polymer adhesion prevention to a roll in a processing treatment.

### MODES FOR CARRYING OUT THE INVENTION

In the present invention, the fluorine-containing monomer (a), the fluorine-free alkyl acrylate monomer (b), and the fluorine-free cyclic hydrocarbon group-containing acrylate monomer (c) are used as the monomers constituting the repeating units of the fluorine-containing polymer. Optionally, the fluorine-containing polymer has repeating units derived from another monomer (especially, a fluorine-free monomer) other than the monomers (a), (b) and (c), for example, (d) repeating units derived from a halogenated olefin monomer, and/or (e) repeating units derived from a fluorine-free monomer other than the monomers (b), (c) and (d)

An example of the fluorine-free monomer (e) is (e1) a fluorine-free crosslikable monomer,

In the present invention, the combination of the monomers constituting the repeating units of the fluorine-containing polymer may be as follows, for example,

(1) Monomer (a)+monomer (b)+monomer (c);

(2) Monomer (a)+monomer (b)+monomer (c)+monomer d):

(3) Monomer (a)+monomer (b)+monomer (c)+monomer (e);
(For example, monomer (a)+monomer (b)+monomer (c)+monomer (e1)); and

(4) Monomer (a)+monomer (b)+monomer (c)+monomer (d) monomer (e);
(For example, monomer (a)+monomer (b)+monomer (c)+monomer (d)+monomer (e1))

The combination of the monomers constituting the repeating units of the fluorine-containing polymer may be the combination (1), (2) or (3). The combination (4), however, is especially preferable.

The fluorine-containing polymer of the present invention can be used as an active component of a water- and oil-repellent agent, a soil resistant agent and a soil release agent.

### (a) Flourine-Containing Monomer

The fluorine-containing monomer is an acrylate ester monomer or acrylamide monomer wherein the α-position is substituted with a monovalent organic group or a halogen atom. The monovalent organic group at the α-position of the fluorine-containing monomer may be a methyl group, but preferably it is not a methyl group.

The fluorine-containing monomer (a) is a fluorine-containing monomer represented by the formula:

CH₂═C(—X)—C(═O)—Y—Z—Rf

wherein X is a monovalent organic group or a halogen atom,

Y is —O— or —NH—;

Z is a direct bond or a divalent organic group, and

Rf is a fluoroalkyl group having 1 to 20 carbon atoms.

Z may be, for example, a linear or branched aliphatic group having 1 to 20 carbon atoms, such as a group represented by the formula —(CH₂)ₓ— wherein x is from 1 to 10 or

a group represented by the formula —SO₂N(R¹)R²— or the formula —CON(R¹)R²— wherein R¹ is an alkyl group having 1 to 10 carbon atoms and R² is a linear alkylene group or branched alkylene group having 1 to carbon atoms or a group represented by the formula —CH₂CH(OR³)CH₂—(Ar—O)ₚ— wherein R³ is a hydrogen atom or an acyl group having 1 to 10 carbon atoms (for example, formyl group or acetyl group), Ar is a arylene group optionally having a substituent or a group represented by the formula —Ar—CH₂—(O)_{q}— wherein Ar is an arylene group optionally having a substituent group and q is 0 or 1, or a —(CH₂)ₘ—SO₂—(CH₂)ₙ— group or —(CH₂)ₘ—S—(CH₂)ₙ— group wherein m is 1-10 and n is 0-10. Specific examples of X are Cl, Br, I, F, CN and CF₃.

The fluorine-containing monomer (a) is preferably an acrylate ester or acrylamide represented by the formula:

CH₂═C(—X)—C(═O)—Y—Z—Rf (1)

wherein X is a linear or branched alkyl group having 2-21 carbon atoms, a fluorine atom, a chlorine atom, a bromine atom, an iodine atom, a CFX¹X² group (where X¹ and X² are a hydrogen atom, a fluorine atom, a chlorine atom, a bromine atom or an iodine atom), a cyano group, a linear or branched fluoroalkyl group having 1-21 carbon atoms, a substituted or unsubstituted benzyl group, or a substituted or unsubstituted phenyl group;

Y is —O— or —NH—;

Z is an aliphatic group having 1-10 carbon atoms, an aromatic group or cycloaliphatic group having 6-18 carbon atoms,

a —CH₂CH₂N(R¹)SO₂— group (where R¹ is an alkyl group having 1-4 carbon atoms),
a —CH₂CH(OZ¹)CH₂-(Ph-O)ₚ— group (where Z¹ is a hydrogen atom or an acetyl group, Ph is a phenylene group, and p is 0 or 1),
a —(CH₂)-Ph-O— group (where Ph is a phenylene group and n is 0-10), or
a —(CH₂)ₘ—SO₂—(CH₂)ₙ— group or a —(CH₂)ₘ—S—(CH₂)ₙ— group (where m is 1-10 and n is 0-10),
Rf is a linear or branched fluoroalkyl group having 1 to 20 carbon atoms.

The fluorine-containing monomer (a) is acrylate wherein the α-position is substituted with the halogen atom, etc. X is preferably a chlorine atom.

In the formula (I), the Rf group is preferably a perfluoroalkyl group. The carbon number of the Rf group is preferably 1 to 6, particularly from 4 to 6. Examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂ and —C₈F₁₇.

Z is preferably an aliphatic group having 1-10 carbon atoms, an aromatic group or cycloaliphatic group having 6-18 carbon atoms,

a —CH₂CH₂N(R¹)SO₂— group (where R¹ is an alkyl group having 1-4 carbon atoms),
a —CH₂CH(OZ¹)CH₂-(Ph-O)ₚ— group (where Z¹ is a hydrogen atom or an acetyl group, Ph is a phenylene group, and p is 0 or 1),
a —(CH₂)ₙ-Ph-O— group (where Ph is a phenylene group and n is 0-10)
a —(CH₂)ₘ—SO₂—(CH₂)ₙ— group or a —(CH₂)ₘ—S—(CH₂)ₙ— group (where m is 1-10 and n is 0-10). The aliphatic group is preferably an alkylene group (having particularly 1 to 4, for example, 1 or 2 carbon atoms). The aromatic group or the cyclic aliphatic group may be substituted or unsubstituted. The S group or the SO₂ group may directly bond to the Rf group.

Specific examples of the fluorine-containing monomer (a) include, but are not limited to, the following:

CH₂═C(—F)—C(═O)—O—(CH₂)₂—Rf

CH₂═C(—Cl)—C(═O)—O—(CH₂)₂—Rf

CH₂═C(—F)—C(═O)—O—(CH₂)₂—S—Rf

CH₂═C(—F)—C(═O)—O—(CH₂)₂—S—(CH₂)₂—Rf

CH₂═C(—F)—C(═O)—O—(CH₂)₂—SO₂—Rf

CH₂═C(—F)—C(═O)—O—(CH₂)₂—SO₂—(CH₂)₂—Rf

CH₂═C(—F)—C(═O)—NH—(CH₂)₂—Rf

CH₂═C(—Cl)—C(═O)—O—(CH₂)₂—S—Rf

CH₂═C(—Cl)—C(═O)—O—(CH₂)₂—S—(CH₂)₂—Rf

CH₂═C(—Cl)—C(═O)—O—(CH₂)₂—SO₂—Rf

CH₂═C(—Cl)—C(═O)—O—(CH₂)₂—SO₂—(CH₂)₂—Rf

CH₂═C(—Cl)—C(═O)—NH—(CH₂)₂—Rf

CH₂═C(—CF₃)—C(═O)—O—(CH₂)₂—S—Rf

CH₂═C(—CF₃)—C(═O)—O—(CH₂)₂—S—(CH₂)₂—Rf

CH₂═C(—CF₃)—C(═O)—O—(CH₂)₂—SO₂—Rf

CH₂═C(—CF₃)—C(═O)—O—(CH₂)₂—SO₂—(CH₂)₂—Rf

CH₂═C(—CF₃)—C(═O)—NH—(CH₂)₂—Rf

CH₂═C(—CF₂H)—C(═O)—O—(CH₂)₂—S—Rf

CH₂═C(—CF₂H)—C(═O)—O—(CH₂)₂—S—(CH₂)₂—Rf

CH₂═C(—CF₂H)—C(═O)—O—(CH₂)₂—SO₂—Rf

CH₂═C(—CF₂H)—C(═O)—O—(CH₂)₂—SO₂—(CH₂)₂—Rf

CH₂═C(—CF₂H)—C(═O)—NH—(CH₂)₂—Rf

CH₂═C(—CN)—C(═O)—O—(CH₂)₂—S—Rf

CH₂═C(—CN)—C(═O)—O—(CH₂)₂—S—(CH₂)₂—Rf

CH₂═C(—CN)—C(═O)—O—(CH₂)₂—SO₂—Rf

CH₂═C(—CN)—C(═O)—O—(CH₂)₂—SO₂—(CH₂)₂—Rf

CH₂═C(—CN)—C(═O)—NH—(CH₂)₂—Rf

CH₂═C(—CF₂CF₃)—C(═O)—O—(CH₂)₂—S—Rf

CH₂═C(—CF₂CF₃)—C(═O)—O—(CH₂)₂—S—(CH₂)₂—Rf

CH₂═C(—CF₂CF₃)—C(═O)—O—(CH₂)₂—SO₂—Rf

CH₂═C(—CF₂CF₃)—C(═O)—O—(CH₂)₂—SO₂—(CH₂)₂—Rf

CH₂═C(—CF₂CF₃)—C(═O)—NH—(CH₂)₂—Rf

CH₂═C(—F)—C(═O)—O—(CH₂)₃—S—Rf

CH₂═C(—F)—C(═O)—O—(CH₂)₃—S—(CH₂)₂—Rf

CH₂═C(—F)—C(═O)—O—(CH₂)₃—SO₂—Rf

CH₂═C(—F)—C(═O)—O—(CH₂)₃—SO₂—(CH₂)₂—Rf

CH₂═C(—F)—C(═O)—NH—(CH₂)₃—Rf

CH₂═C(—Cl)—C(═O)—O—(CH₂)₃—S—Rf

CH₂═C(—Cl)—C(═O)—O—(CH₂)₃—S—(CH₂)₂—Rf

CH₂═C(—Cl)—C(═O)—O—(CH₂)₃—SO₂—Rf

CH₂═C(—Cl)—C(═O)—O—(CH₂)₃—SO₂—(CH₂)₂—Rf

CH₂═C(—CF₃)—C(═O)—O—(CH₂)₃—S—Rf

CH₂═C(—CF₃)—C(═O)—O—(CH₂)₃—S—(CH₂)₂—Rf

CH₂═C(—CF₃)—C(═O)—O—(CH₂)₃—SO₂—Rf

CH₂═C(—CF₃)—C(═O)—O—(CH₂)₃—SO₂—(CH₂)₂—Rf

CH₂═C(—CF₂H)—C(═O)—O—(CH₂)₃—S—Rf

CH₂═C(—CF₂H)—C(═O)—O—(CH₂)₃—S—(CH₂)₂—Rf

CH₂═C(—CF₂H)—C(═O)—O—(CH₂)₃—SO₂—Rf

CH₂═C(—CF₂H)—C(═O)—O—(CH₂)₃—SO₂—(CH₂)₂—Rf

CH₂═C(—CN)—C(═O)—O—(CH₂)₃—S—Rf

CH₂═C(—CN)—C(═O)—O—(CH₂)₃—S—(CH₂)₂—Rf

CH₂═C(—CN)—C(═O)—O—(CH₂)₃—SO₂—Rf

CH₂═C(—CN)—C(═O)—O—(CH₂)₃—SO₂—(CH₂)₂—Rf

CH₂═C(—CF₂CF₃)—C(═O)—O—(CH₂)₃—S—Rf

CH₂═C(—CF₂CF₃)—C(═O)—O—(CH₂)₃—S—(CH₂)₂—Rf

CH₂═C(—CF₂CF₃)—C(═O)—O—(CH₂)₃—SO₂—Rf

CH₂═C(—CF₂CF₃)—C(═O)—O—(CH₂)₂—SO₂—(CH₂)₂—Rf

wherein Rf is a fluoroalkyl group having 1 to 20 carbon atoms.

### (b) Alkyl Acrylate Monomer

The alkyl acrylate monomer (namely, a fluorine-free alkyl acrylate monomer) is an alkyl acrylate ester having C₆-C₁₃ alkyl group (namely, C₆₋₁₃ alkyl-containing alkyl acrylate). The alkyl acrylate monomer is a fluorine-free monomer which does not comprise a fluorine atom. In the alkyl acrylate monomer, the α-position may be a hydrogen atom, a methyl group, a halogen atom other than a fluorine atom (for example, a chlorine atom, a bromine atom and a iodine atom). The α-position is preferably a hydrogen atom or a methyl group, and particularly preferably a hydrogen atom.

The alkyl acrylate monomer is preferably an alkyl acrylate ester represented by the formula:

CH₂═CA¹COOA²

wherein A¹ is a hydrogen atom, a methyl group or a halogen atom other than a fluorine atom (for example, a chlorine atom, a bromine atom and an iodine atom), and
A² is an alkyl group expressed by CₙH₂ₙ₊₁ (n=6-13).

The carbon number of the alkyl group is 6-13, preferably 8-12, for example, 10-12. In the case that the carbon number of the alkyl group is in the mentioned range, excellent water-repellency and excellent durability at repeated wash can be imparted, even if the fluorine-containing polymer in the treatment agent has a low concentration.

The alkyl acrylate monomer is preferably hexyl (meth)acrylate, heptyl (meth)acrylate, octyl (meth)acrylate, nonyl (meth)acrylate, decyl (meth)acrylate, undecyl (meth)acrylate, lauryl (meth)acrylate and/or tridecyl (meth)acrylate. Lauryl (meth)acrylate is particularly preferable.

Preferably, the fluorine-containing polymer of the present invention does not have repeating units derived from an monomer wherein A² is an alkyl group (for example, stearyl group) having at least 15 carbon atoms in the above-mentioned formula (CH₂=CA¹COOA²).

### (c) Fluorine-Free Acrylate Monomer Having a Cyclic Hydrocarbon Group

The fluorine-free acrylate monomer having a cyclic hydrocarbon group (c) is a monomer free from a fluorine atom. The fluorine-free acrylate monomer (c) does not have a crosslinkable functional group. Unlike the crosslikable monomer (e1), the fluorine-free acrylate monomer (c) is non-crosslinkable.

The fluorine-free acrylate monomer (c) may be a compound represented by the formula:

CH₂═CA-C(═O)—O-Q

wherein A is a hydrogen atom, a methyl group or a halogen atom other than a fluorine atom (for example, a chlorine atom, a bromine atom, and a iodine atom), and
Q is a cyclic hydrocarbon group.

The cyclic hydrocarbon group has 4 to 30, preferably 4 to 20 carbon atoms. Examples of the cyclic hydrocarbon group are a cycloaliphatic group having 4-30 carbon atoms, preferably 4-20 carbon atoms, particularly 5-20 carbon atoms, an aromatic hydrocarbon group having 6-30 carbon atoms, preferably 6-20 carbon atoms, and an araliphatic hydrocarbon group having 7-30 carbon atoms, preferably 7-20 carbon atoms.

Examples of the cyclic hydrocarbon group include a saturated or unsaturated, monocyclic group, polycyclic group or bridged ring group. The cyclic hydrocarbon group is preferably a saturated group. The number of carbon atoms in the cyclic hydrocarbon group is particularly preferably at most 15, for example, at most 10. Strong water repellency can be given by the above-mentioned range of the carbon number of the cyclic hydrocarbon group.

Specific examples of the cyclic hydrocarbon group include a cyclohexyl group, a t-butyl cyclohexyl group, an isobornyl group, a dicyclopentanyl group and a dicyclopentenyl group. The acrylate group is preferably an acrylate group or a methacrylate group, particularly preferably a methacrylate group. Specific examples of the cyclic hydrocarbon group-containing monomer include cyclohexyl (meth)acrylate, t-butyl cyclohexyl (meth)acrylate, benzyl (meth)acrylate, isobornyl (meth)acrylate, dicyclopentanyl (meth)acrylate, dicyclopentenyl (meth)acrylate, dicyclopentanyloxyethyl (meth)acrylate, tricyclopentanyl (meth)acrylate, adamantyl (meth)acrylate, 2-methyl-2-adamantyl (meth)acrylate and 2-ethyl-2-adamanthyl (meth)acrylate.

### (d) Halogenated Olefin Monomer

The halogenated olefin monomer is a fluorine-free monomer which does not contain a fluorine atom. Preferably, the halogenated olefin monomer is an olefin having 2-20 carbon atoms, for example, 2-5 carbon atoms and substituted by 1-10 chlorine atoms, bromine atoms or iodine atoms. Preferably, the halogenated olefin monomer is a chlorinated olefin having 2-20 carbon atoms, particularly an olefin having 2-5 carbon atoms carbon and 1-5 chlorine atoms. Preferable examples of the halogenated olefin monomer are a vinyl halide such as vinyl chloride, vinyl bromide and vinyl iodide, and a vinylidene halide such as vinylidene chloride, vinylidene bromide and vinylidene iodide. Vinyl chloride is preferable, since water repellency or water resistance (particularly durability of water repellency or water resistance) is high.

### (e) Fluorine-Free Monomer

The fluorine-free monomer (e) is a fluorine-free monomer other than the alkyl acrylate monomer (b), the fluorine-free acrylate monomer having a cyclic hydrocarbon group (c) and the halogenated olefin monomer (d). The fluorine-free monomer (e) may be a fluorine-free crosslikable monomer (e1) or another monomer (e2).

### (e1) Fluorine-Free Crosslinkable Monomer

The fluorine-containing polymer of the present invention may have repeating units derived from the fluorine-free crosslinkable monomer (e1). The fluorine-free crosslinkable monomer (e1) is a monomer free from a fluorine atom. The fluorine-free crosslinkable monomer (e1) may be a fluorine-free compound having at least two reactive groups and/or carbon-carbon double bonds. The fluorine-free crosslinkable monomer (e1) may be a compound which has at least two carbon-carbon double bonds or a compound which has at least one carbon-carbon double bond and at least one reactive group. Examples of the reactive group include a hydroxyl group, an epoxy group, a chloromethyl group, a blocked isocyanate group, an amino group and a carboxyl group. The fluorine-free crosslinkable monomer (e1) may be a mono(meth)acrylate, di(meth)acrylate, or mono(meth)acrylamide having a reactive group. Alternatively, the fluorine-free crosslinkable monomer (e1) may be di(meth)acrylate.

Examples of the fluorine-free crosslinkable monomer (e1) include, but are not limited to, diacetone(meth)acrylamide, (meth)acrylamide, N-methylol(meth)acrylamide, hydroxymethyl (meth)acrylate, hydroxyethyl (meth)acrylate, 3-chloro-2-hydroxypropyl (meth)acrylate, 2-acetoacetoxyethyl (meth)acrylate, butadiene, isoprene, chloroprene, glycidyl (meth)acrylate, 1,6-hexanediol di(meth)acrylate, and neopentylglycol di(meth)acrylate.

The fluorine-free monomer (e2) is another monomer other than the monomer (e1). Examples of other monomer include ethylene, vinyl acetate, styrene, alpha-methylstyrene, p-methylstyrene, N,N-di ethyl(meta) acrylamide, N,N-dimethylpropyl(meth)acrylamide, methylolized diacetone (meth)acrylamide, vinyl alkyl ether, alkyl halide vinyl ether, vinyl alkyl ketone, an aziridinyl ethyl (meth)acrylate, aziridinyl (meth)acrylate, polyoxyalkylene (meth)acrylate, methyl polyoxyalkylene (meth)acrylate, glycerol mono(meth)acrylate, 2-ethylhexyl polyoxyalkylene (meth)acrylate, polyoxyalkylene di(meth)acrylate, polysiloxane-containing (meth)acrylate, triallylcyanurate, allyl glycidyl ether, allyl acetate, N-vinylcarbazole, maleimide, N-methylmaleimide, (2-dimethylamino)ethyl (meth)acrylate, (meth)acrylate having silicone in a side chain, (meth)acrylate having a urethane bond, alkylene di(meth)acrylate and polyoxyalkylene di(meth)acrylate.

Preferably, the fluorine-free monomer (e) comprises both or one of a (meth)acrylate having a hydroxyl group and a (meth)acrylamide compound. In the hydroxyl group-containing (meth)acrylate, the number of the hydroxyl groups may be 1 to 5, preferably 2 to 4, for example, 2 or 3. A (meth)acrylate having a —CH(OH)—CH₂—OH group is particularly preferable. The (meth)acrylamide compound is a monomer having a (meth)acrylamide group. Preferably, the (meth)acrylamide compound has active hydrogen. Diacetone (meth)acrylamide is particularly preferred. The hydroxyl group-containing (meth)acrylate and the (meth)acrylamide compound can enhance water repellency. Particularly preferably, both of the hydroxyl group-containing (meth)acrylate and (meth)acrylamide compound (for example, a weight ratio of from 1:9 to 1:9) are used as the fluorine-free monomer (e).

When the fluorine-free acrylate monomer (c) and/or the fluorine-free crosslinkable monomer (e1) are copolymerized, various properties such as water- and oil-repellency, soil resistance, cleaning durability and washing durability of said properties, solubility in solvents, hardness and feeling may be improved depending on the necessity.

The term “acrylate” or “acrylamide” as used herein means not only a compound wherein the α-position is a hydrogen atom but also a compound wherein which the α-position is substituted with another group (for example, a monovalent organic group including a methyl group or a halogen atom). The term “(meth)acrylate” as used herein means an acrylate or methacrylate, and the term “(meth)acrylamide” as used herein means an acrylamide or methacrylamide.

Each of the monomer (a), the monomer (b), the monomer (c), the monomer (d) and the monomer (e) (for example, each of the monomers (e1) and (e2)) may be alone, or may be in a combination of at least two.

The amount of the fluorine-containing monomer (a) may be 20% by weight or more, preferably 30% by weight to 90% by weight, based on the fluorine-containing polymer.

The amount of the alkyl acrylate monomer (b) may be 5-300 parts by weight, for example, 10-200 parts by weight, particularly 20-100 parts by weight, especially 30-80 parts by weight,

the amount of the fluorine-free cyclic hydrocarbon group-containing acrylate monomer (c) may be 0.1-800 parts by weight, for example, 1-300 parts by weight, particularly 2-200 parts by weight, especially 3-100 parts by weight,
the amount of the halogenated olefin (d) may be 300 parts by weight or less, for example, 5-200 parts by weight, particularly 10-150 parts by weight, especially 15-100 parts by weight,
the amount of the fluorine-free monomer (e) may be 1000 parts by weight or less, for example, 0.1-400 parts by weight, particularly 0.5-250 parts by weight, especially 1-50 parts by weight,
based on 100 parts by weight of fluorine-containing monomer (a).

In the fluorine-containing polymer, the amount of each of the fluorine-free crosslikable monomer (e1) and (e2) may be 80 parts by weight or less, for example, 50 parts by weight or less, particularly 0.1-30 parts by weight, especially 1-20 parts by weight, based on 100 parts by weight of fluorine-containing monomer (a).

The alkyl acrylate monomer (b) can give the excellent water-repellency and the excellent durability in repeated wash, even if the fluorine-containing polymer in the treatment agent has a low concentration. The halogenated olefin (d) can give excellent water-repellency, washing durability, and dry-cleaning durability, even if the fluorine-containing polymer in the treatment agent has a further low concentration. The fluorine-free cyclic hydrocarbon group-containing acrylate monomer (c) can give excellent strong water repellency. The fluorine-free crosslikable monomer (e1) can enhance the washing durability.

The fluorine-containing polymer of the present invention can be produced by any of conventional polymerization methods and the polymerization condition can be optionally selected. The polymerization method includes, for example, a solution polymerization, a suspension polymerization and an emulsion polymerization.

In a solution polymerization, there can be used a method of dissolving the monomer(s) into an organic solvent in the presence of a polymerization initiator, replacing the atmosphere by nitrogen, and stirring the mixture with heating at the temperature within the range from 30° C. to 120° C. for 1 hour to 10 hours. Examples of the polymerization initiator include azobisisobutyronitrile, benzoyl peroxide, di-tert-butyl peroxide, lauryl peroxide, cumene hydroperoxide, t-butyl peroxypivalate and diisopropyl peroxydicarbonate. The polymerization initiator may be used in the amount within the range from 0.01 to 20 parts by weight, for example, from 0.01 to 10 parts by weight, based on 100 parts by weight of total of the monomers.

The organic solvent is inert to the monomer, and dissolves the monomer, and examples of the organic solvent include an ester (for example, an ester having 2-30 carbon atoms, specifically ethyl acetate and butyl acetate), a ketone (for example, a ketone of 2-30 carbon atoms, specifically methyl ethyl ketone and diisobutyl ketone), and an alcohol (for example, an alcohol having 1-30 carbon atoms, specifically isopropyl alcohol). Specific examples of the organic solvent include acetone, chloroform, HCHC225, isopropyl alcohol, pentane, hexane, heptane, octane, cyclohexane, benzene, toluene, xylene, petroleum ether, tetrahydrofuran, 1,4-dioxane, methyl ethyl ketone, methyl isobutyl ketone, diisobutyl ketone, ethyl acetate, butyl acetate, 1,1,2,2-tetrachloroethane, 1,1,1-trichloroethane, trichloroethylene, perchloroethylene, tetrachlorodifluoroethane and trichlorotrifluoroethane. The organic solvent may be used in the amount within the range from 10 to 2,000 parts by weight, for example, from 50 to 1,000 parts by weight, based on 100 parts by weight of total of the monomers,

In an emulsion polymerization, there can be used a method of emulsifying monomers in water in the presence of a polymerization initiator and an emulsifying agent, replacing the atmosphere by nitrogen, and polymerizing with stirring, for example, at the temperature within the range from 50° C. to 80° C. for 1 hour to 10 hours. As the polymerization initiator, for example, water-soluble initiators (e.g., benzoyl peroxide, lauroyl peroxide, t-butyl perbenzoate, 1-hydroxycyclohexyl hydroperoxide, 3-carboxypropionyl peroxide, acetyl peroxide, azobisisobutylamidine dihydrochloride, azobisisobutyronitrile, sodium peroxide, potassium persulfate and ammonium persulfate) and oil-soluble initiators (e.g., azobisisobutyronitrile, benzoyl peroxide, di-tert-butyl peroxide, lauryl peroxide, cumene hydroperoxide, t-butyl peroxypivalate and diisopropyl peroxydicarbonate) are used. The polymerization initiator may be used in the amount within the range from 0.01 to 10 parts by weight based on 100 parts by weight of the monomers.

In order to obtain a polymer dispersion in water, which is superior in storage stability, it is preferable that the monomers are dispersed in water by using an emulsifying device capable of applying a strong shearing energy (e.g., a high-pressure homogenizer and an ultrasonic homogenizer) and then polymerized with using an oil-soluble polymerization initiator. As the emulsifying agent, various emulsifying agents such as an anionic emulsifying agent, a cationic emulsifying agent and a nonionic emulsifying agent can be used in the amount within the range from 0.5 to 20 parts by weight based on 100 parts by weight of the monomers. The anionic emulsifier, the nonionic emulsifier and/or the cationic emulsifier may be used. The nonionic emulsifier is preferably used. Preferably, the emulsifier consists of the nonionic emulsifier. When the monomers are not completely compatibilized, a compatibilizing agent (e.g., a water-soluble organic solvent and a low-molecular weight monomer) capable of sufficiently compatibilizing them is preferably added to these monomers. By the addition of the compatibilizing agent, the emulsifiability and polymerizability can be improved.

Examples of the water-soluble organic solvent include acetone, methyl ethyl ketone, ethyl acetate, propylene glycol, dipropylene glycol monomethyl ether, dipropylene glycol, tripropylene glycol and ethanol. The water-soluble organic solvent may be used in the amount within the range from 1 to 50 parts by weight, e.g., from 10 to 40 parts by weight, based on 100 parts by weight of water. Examples of the low-molecular weight monomer include methyl methacrylate, glycidyl methacrylate and 2,2,2-trifluoroethyl methacrylate. The low-molecular weight monomer may be used in the amount within the range from 1 to 50 parts by weight, e.g., from 10 to 40 parts by weight, based on 100 parts by weight of total of monomers.

A chain transfer agent may be used in the polymerization. The molecular weight of the copolymer can be changed according to the amount of the chain transfer agent used. Examples of a chain transfer agent include a mercaptan group-containing compound (especially alkyl mercaptan (for example, carbon numbers 1-30)), such as lauryl mercaptan, thioglycol, and thio glycerol, and a mineral salt such as sodium hypophosphite and sodium hydrogensulfite. The amount of the chain transfer agent may be within the range from 0.01 to 10 parts by weight, for example, from 0.1 to 5 parts by weight, based on 100 parts by weight of total of the monomers.

The resultant fluorine-containing polymer, optionally after diluted or dispersed in water, an organic solvent, etc., can take arbitrary forms, such as an emulsion, an organic solvent solution and an aerosol to give the treatment agent. The fluorine-containing polymer acts as an effective component (an active ingredient) of the treatment agent. The treatment agent generally comprises the fluorine-containing polymer and a medium (particularly a liquid medium) (for example, an organic solvent and/or water). The concentration of the fluorine-containing polymer may be, for example, from 0.01 to 50 by weight, based on the treatment agent.

The treatment agent of the present invention preferably comprises a fluorine-containing polymer and an aqueous medium. As used herein, the term “aqueous medium” means a medium consisting of water alone, as well as a medium comprising, in addition to water, an organic solvent (water-soluble organic solvent) (the amount of the organic solvent is at most 80 parts by weight, for example, 0.1 to 50 parts by weight, particularly 5 to 30 parts by weight, based on 100 parts by weight of water). The fluorine-containing polymer is preferably produced by preparing a dispersion of the fluorine-containing polymer by the emulsion polymerization. The treatment agent is preferably an aqueous dispersion of the particles of a fluorine-containing polymer dispersed in an aqueous medium.

The fluorine-containing polymer according to the present invention may be applied to the substrate article as a treatment agent by arbitrary methods, depending on the type of the substrate article, the above-mentioned form of the agent (such as an emulsion, an organic solvent solution and an aerosol), etc. For example, when the treatment agent is an aqueous emulsion or an organic solvent solution, a method of attaching the fluorine-containing polymer to a surface of the substrate by a known coating procedure, such as an immersion coating process and a spray coating process, and subsequently drying may be adopted. Under this circumstance, a heat-treatment such as curing may be used if needed.

If necessary, it is also possible to use another blender together. Examples of the other blender include a water- and oil-repellent agent, a wrinkle-resistant agent, a shrink-proofing agent, a flame retarder, a cross linking agent, an antistatic agent, a softening agent, a water soluble polymer, such as polyethylene glycol and polyvinyl alcohol, a wax emulsion, an antibacterial agent, a pigment, and a coating material. These blenders may be added and used for a treatment bath at the time of treating the substrate, or beforehand, if possible, these blenders may be used by mixing with the fluorine-containing polymer of the present invention.

The fluorine-containing polymer can be applied to a substrate cloth with any of methods known in order to form a film of a polymer on the substrate cloth. Generally, the film of the fluorine-containing polymer can be formed on the substrate by applying the liquid comprising the fluorine-containing polymer and the fluid medium on the cloth substrate and then removing the fluid medium by drying, etc. In the liquid comprising the fluorine-containing polymer and the fluid medium, the concentration of the fluorine-containing polymer may be for example, 0.01 to 20% by weight, especially 0.05 to 10% by weight. The substrate cloth may be dipped in the liquid, or the liquid may be adhered or sprayed on the substrate cloth. The substrate cloth to which the liquid is applied is dried and preferably heated at 100° C.-200° C., for example, in order to show the liquid repellency.

The treated article include a textile, masonry, a filter (for example, an electrostatic filter), a dust protective mask, glass, paper, wood, leather, fur, asbestos, brick, cement, metal and oxide, ceramics, plastics, a coated surface and a plaster, to which the treated article is not limited. The textile is particularly useful. The textile includes various examples. Examples of the textile include animal- or vegetable-origin natural fibers such as cotton, hemp, wool and silk; synthetic fibers such as polyamide, polyester, polyvinyl alcohol, polyacrylonitrile, polyvinyl chloride and polypropylene; semi-synthetic fibers such as rayon and acetate; inorganic fibers such as glass fiber, carbon fiber and asbestos fiber; and a mixture of these fibers. The textile may be in any form such as a fiber, a yarn and a fabric.

In the present invention, the substrate is treated with the treatment agent. The term “treatment” means that the treatment agent is applied to the substrate by immersion, spray, coating or the like. The treatment gives the result that a fluorine-containing copolymer which is an active component of the treatment agent is penetrated into internal parts of the substrate and/or adhered to surfaces of the substrate.

### EXAMPLES

The present invention is now described in detail by way of Examples, Comparative Examples and Test Examples. However, the present invention is not limited to these Examples.

In the following Examples, parts and % are parts by weight and % by weight, unless otherwise specified.

The properties were measured as follows:

### Low Concentration Water Repellency.

A treatment liquid was prepared by diluting the aqueous dispersion liquid of polymer with water so that a solid concentration was 0.15%, 0.23% and 0.3% by weight. After immersing a nylon cloth (40 denier, taffeta) in the treatment liquid, squeezing the cloth with an mangle at 4 kg/cm² and 4 m/min. with a mangle and heat-treating the cloth for 1 minute at 170° C., the water repellency of the treated cloth was evaluated.

The water repellency is expressed by water repellency No. (as shown in the following Table I) according to a spray method of JIS-L-1092. The suffix “+” attached to the numeral value means that the property is slightly better than the property indicated by said numeral value, and the suffix “−” attached to the numeral value means that the property is slightly worse.

TABLE 1

| Water | |
|---|---|
| repellency No. | State |
| 100 | No wet or water droplets adhesion on surface |
| 90 | No wet but small water droplets adhesion on surface |
| 80 | Separate small water droplets-like wet on surface |
| 70 | Wet on half of surface and separate small wet which |
| | penetrates fabric |
| 50 | Wet on whole surface |
| 0 | Wet on front and back whole surfaces |

### Durable Water Repellency

A treatment liquid was prepared by diluting the aqueous dispersion liquid of polymer with water so that a solid concentration was 1.0% by weight, and adding blocked isocyanate (“ELASTRON BN-69” manufactured by Dai-Ichi Kogyo Seiyaku Co., Ltd.) to give a concentration of 0.25% by weight. After immersing a test cloth in the treatment liquid, squeezing the cloth with an mangle at 4 kg/cm² and 4 m/min. with a mangle and heat-treating a nylon cloth (70 denier, taffeta) at 170° C. for 1 minute, a polyester (70 denier, taffeta) at 120° C. for 2 minutes and a polyester (20 denier, rip) at 100° C. for 2 minutes, the water repellency of the treated cloth was evaluated.

The water repellency was evaluated, before wash (HL0) and after repeating a wash 10 times or 20 times (water-repellent durability) (HL10 or HL20) (durability of water repellency) according to AATCC 88B (1) (III). The water repellency was expressed by water repellency No. (as shown in the following Table I) according to a spray method of JIS-L-1092, as in the low concentration water repellency.

### Tackiness of Polymer

A liquid obtained by dispersing 10 g of an aqueous dispersion liquid of a polymer in 20 g of methanol was centrifuged at 10.000 rpm for 60 minutes to separate the polymer from the emulsifier, whereby obtaining a sample polymer for measurement. The tackiness of this polymer was measured by a tacking testing machine TAC-2 (manufactured by RHESCA). The tackiness was measured by using a sample polymer amount of 0.1 g, a measurement temperature of 40° C., and a load of 500 gf.

### Example 1

Into a 1 L autoclave, Monomer A: C₆F₁₃CH₂CH₂OCOC(Cl)═CH₂ (C6SFCLA) (110 g), Monomer B: lauryl methacrylate (LMA) (48 g), Monomer D: cyclohexyl methacrylate (CHMA) (42 g), pure water (446 g), tripropylene glycol (76 g), polyoxyethylene lauryl ether (10.2 g), polyoxyethylene oleyl ether (2.47 g) and polyoxyethylene isotridecyl ether (7.6 g) were charged, and then warmed at 60° C. and dispersed for emulsification by a high pressure homogenizer. After the emulsification, lauryl mercaptan (2.5 g) and Monomer C: vinyl chloride (VCl) (62 g) was injected. 2,2-Azobis(2-amidinopropane) dihydrochloride (1.6 g) was added, and the reaction was conducted at 70° C. for 3 hours to give an aqueous dispersion liquid of polymer. Water repellency (water- and oil-repellency) and tackiness of the aqueous dispersion having a solid content of 30% by weight adjusted with pure water were measured. Results are shown in Table 2.

### Example 2

An aqueous dispersion of polymer was obtained in the same manner as Example 1 except that lauryl acrylate (LA) as Monomer B was used, Monomer C: vinyl chloride (VCl) was omitted and Monomer F: glycerol monomethacrylate (GLM) was added (the amounts of components are shown in Table 2). Water repellency and tackiness of the aqueous dispersion having a solid content of 30% adjusted with pure water were measured. Results are shown in Table 2.

### Example 3

An aqueous dispersion of polymer was obtained in the same manner as Example 1 except that octyl acrylate (OA) as Monomer B was used, Monomer E: diacetone acrylamide (DAAM) and Monomer F: glycerol monomethacrylate (GLM) were added (the amounts of components are shown in Table 2). Water repellency and tackiness of the aqueous dispersion having a solid content of 30% adjusted with pure water were measured. Results are shown in Table 2.

### Example 4

An aqueous dispersion of polymer was obtained in the same manner as Example 3 except that isooctyl acrylate (iso-OA) as Monomer B was used (the amounts of components are shown in Table 2). Water repellency and tackiness of the aqueous dispersion having a solid content of 30% adjusted with pure water were measured. Results are shown in Table 2.

### Example 5

An aqueous dispersion of polymer was obtained in the same manner as Example 3 except that isodecyl acrylate (iso-DA) as Monomer B was used (the amounts of components are shown in Table 2). Water repellency and tackiness of the aqueous dispersion having a solid content of 30% adjusted with pure water were measured. Results are shown in Table 2.

### Example 6

An aqueous dispersion of polymer was obtained in the same manner as Example 3 except that lauryl acrylate (LA) as Monomer B was used (the amounts of components are shown in Table 2). Water repellency and tackiness of the aqueous dispersion having a solid content of 30% adjusted with pure water were measured. Results are shown in Table 2.

### Example 7

An aqueous dispersion of polymer was obtained in the same manner as Example 6 except that benzyl methacrylate (BzMA) as Monomer B was used, Monomer E: diacetone acrylamide (DAAM) was omitted (the amounts of components are shown in Table 2). Water repellency and tackiness of the aqueous dispersion having a solid content of 30% adjusted with pure water were measured. Results are shown in Table 2.

### Example 8

An aqueous dispersion of polymer was obtained in the same manner as Example 6 except that isobornyl methacrylate (IBMA) as Monomer D was used (the amounts of components are shown in Table 2). Water repellency and tackiness of the aqueous dispersion having a solid content of 30% adjusted with pure water were measured. Results are shown in Table 2.

### Example 9

Into a 1 L autoclave, Monomer A: C₆F₁₃CH₂CH₂OCOC(Cl)═CH₂ (C6SFCLA) (150 g), Monomer B: lauryl acrylate (LA) (70 g), Monomer D: isoboronyl methacrylate (IBMA) (30 g), pure water (446 g), tripropylene glycol (76 g), polyoxyethylene lauryl ether (10.2 g), polyoxyethylene oleyl ether (2.47 g) and polyoxyethylene isotridecyl ether (7.6 g) were charged, and then warmed at 60° C. and dispersed for emulsification by a high pressure homogenizer. After the emulsification, lauryl mercaptan (2.5 g) was injected. 2,2-Azobis(2-amidinopropane) dihydrochloride (1.6 g) was added, and the reaction was conducted at 70° C. for 3 hours to give an aqueous dispersion liquid of polymer. Water repellency and tackiness of the aqueous dispersion having a solid content of 30% by weight adjusted with pure water were measured. Results are shown in Table 2.

### Comparative Example 1

Into a 1 L autoclave, Monomer A: C₅F₁₃CH₂CH₂OCOC(Cl)═CH₂ (C6SFCLA) (150 g), Monomer B: stearyl acrylates (StA) (53 g), pure water (446 g), tripropylene glycol (76 g), polyoxyethylene lauryl ether (10.2 g), polyoxyethylene oleyl ether (2.47 g) and polyoxyethylene isotridecyl ether (7.6 g) were charged, and then warmed at 60° C. and dispersed for emulsification by a high pressure homogenizer. After the emulsification, lauryl mercaptan (2.5 g) and Monomer C: vinyl chloride (VCl) (62 g) was injected. 2,2-Azobis(2-amidinopropane) dihydrochloride (1.6 g) was added, and the reaction was conducted at 70° C. for 3 hours to give an aqueous dispersion liquid of polymer. Water repellency and tackiness of the aqueous dispersion having a solid content of 30% by weight adjusted with pure water were measured. Results are shown in Table 3.

### Comparative Example 2

An aqueous dispersion of polymer was obtained in the same manner as Comparative Example 1 except that vinyl chloride (VCl) as Monomer C was omitted (the amounts of components are shown in Table 3). Water repellency and tackiness of the aqueous dispersion having a solid content of 30% adjusted with pure water were measured. Results are shown in Table 3.

### Comparative Example 3

An aqueous dispersion of polymer was obtained in the same manner as Comparative Example 2 except that C₆F₁₃CH₂CH₂OCOC(CH₃)═CH₂ (C6SFMA) as Monomer A and lauryl acrylate (LA) as Monomer B were used (the amounts of components are shown in Table 3). Water repellency and tackiness of the aqueous dispersion having a solid content of 30% adjusted with pure water were measured. Results are shown in Table 3,

### Comparative Example 4

An aqueous dispersion of polymer was obtained in the same manner as Example 3 except that butyl acrylate (BA) as Monomer B was used (the amounts of components are shown in Table 3). Water repellency and tackiness of the aqueous dispersion having a solid content of 30% adjusted with pure water were measured. Results are shown in Table 3.

### Comparative Example 5

An aqueous dispersion of polymer was obtained in the same manner as Example 3 except that cetyl acrylate (CA) as Monomer B was used (the amounts of components are shown in Table 3). Water repellency and tackiness of the aqueous dispersion having a solid content of 30% adjusted with pure water were measured. Results are shown in Table 3.

### Comparative Example 6

An aqueous dispersion of polymer was obtained in the same manner as Example 3 except that stearyl acrylate (StA) as Monomer B was used (the amounts of components are shown in Table 3). Water repellency and tackiness of the aqueous dispersion having a solid content of 30% adjusted with pure water were measured. Results are shown in Table 3.

### Comparative Example 7

An aqueous dispersion of polymer was obtained in the same manner as Example 3 except that behenyl acrylate (BeA) as Monomer B was used (the amounts of components are shown in Table 3). Water repellency and tackiness of the aqueous dispersion having a solid content of 30% adjusted with pure water were measured. Results are shown in Table 3.

### Comparative Example 8

An aqueous dispersion of polymer was obtained in the same manner as Example 7 except that C₆F₁₃CH₂CH₂OCOC(CH₃)═CH₂ (C6SFMA) as Monomer A, stearyl acrylate (StA) as Monomer B and cyclohexyl methacrylate (CHMA) as Monomer D were used (the amounts of components are shown in Table 3). Water repellency and tackiness of the aqueous dispersion having a solid content of 30% adjusted with pure water were measured. Results are shown in Table 3.

### Comparative Example 9

An aqueous dispersion of polymer was obtained in the same manner as Example 9 except that stearyl acrylate (StA) as Monomer B was used (the amounts of components are shown in Table 3). Water repellency and tackiness of the aqueous dispersion having a solid content of 30% adjusted with pure water were measured. Results are shown in Table 3.

The meanings of the abbreviations in the Tables are as follows:

### <Monomer A>

C6SFCLA: C₆F₁₃CH₂CH₂OCOC(Cl)═CH₂
C6SFMA: C₆F₁₃CH₂CH₂OCOC(CH₃)═CH₂

### <Monomer B>

LA: Lauryl acrylate
LMA: Lauryl methacrylate
OA: Octyl acrylate
iso-OA: Isooctyl acrylate
iso-DA: Isodecyl acrylate
StA: Stearyl acrylate
BA: Butyl acrylate
CA: Cetyl acrylate
BeA: Behenyl acrylate

### <Monomer C>

VCl: Vinyl chloride

### <Monomer D>

CHMA: Cyclohexyl methacrylate
BzMA: Benzyl methacrylate
IBMA: Isobornyl methacrylate

### <Monomer E>

DAAM: Diacetone acrylamide

### <Monomer F>

GLM: Glycerol monomethacrylate

### <Cloth>

Ny: Nylon cloth (70 denier, taffeta)
PET 70d: Polyester (70 denier, taffeta)
PET 20d: Polyester (20 denier, rip)

TABLE 2

| | | | | Ex. 1 | Ex. 2 | Ex. 3 | Ex. 4 | Ex. 5 |
|---|---|---|---|---|---|---|---|---|
| Monomer (A)/charge amount (g) | | | | C6SFCLA/ | C6SFCLA/ | C6SFCLA/ | C6SFCLA/ | C6SFCLA/ |
| | | | | 110 | 110 | 110 | 110 | 110 |
| Monomer (B)/charge amount (g) | | | | LMA/48 | LA/93 | OA/42 | iso- | iso- |
| | | | | | | | OA/42 | DA/42 |
| Monomer (C)/charge amount (g) | | | | VCI/62 | — | VCI/62 | VCI/62 | VCI/62 |
| Monomer (D)/charge amount (g) | | | | CHMA/42 | CHMA/42 | CHMA/42 | CHMA/42 | CHMA/42 |
| Monomer (E)/charge amount (g) | | | | — | — | DAAM/5 | DAAM/5 | DAAM/5 |
| Monomer (F)/charge amount (g) | | | | — | GLM/5 | GLM/5 | GLM/5 | GLM/5 |
| | | | Solid | | | | | |
| | | | conc./ | | | | | |
| | | | number | | | | | |
| | Test | Cure | of times | | | | | |
| Evaluation | cloth | temp. | of wash | | | | | |
| Low | Ny | 170° C. × | 0.15% | 70 | 50+ | 70 | 70 | 70 |
| concentration | | 1 min | 0.23% | 80+ | 70 | 80 | 80 | 80 |
| water | | | 0.30% | 100 | 80+ | 90 | 90 | 90 |
| repellency | | | | | | | | |
| Durable water | Ny | 170° C. × | HL0 | 100 | 100 | 100 | 100 | 100 |
| repellency | | 1 min | HL20 | 90 | 80+ | 90 | 90 | 90 |
| | PET | 120° C. × | HL0 | 100 | 100 | 100 | 100 | 100 |
| | 70 d | 2 min | HL20 | 90 | 80+ | 90 | 90 | 90 |
| | PET | 100° C. × | HL0 | 100 | 100 | 100 | 100 | 100 |
| | 20 d | 2 min | HL20 | 80+ | 80 | 80 | 80+ | 80 |

| | | | | | |
|---|---|---|---|---|---|
| Tackiness of polymer | 14 | 54 | 5 | 5 | 8 |

| | | | | Ex. 6 | Ex. 7 | Ex. 8 | Ex. 9 |
|---|---|---|---|---|---|---|---|
| Monomer (A)/charge amount (g) | | | | C6SFCLA/ | C6SFCLA/ | C6SFCLA/ | C6SFCLA/ |
| | | | | 110 | 110 | 110 | 150 |
| Monomer (B)/charge amount (g) | | | | LA/42 | LA/42 | LA/42 | LA/70 |
| Monomer (C)/charge amount (g) | | | | VCI/62 | VCI/62 | VCI/62 | — |
| Monomer (D)/charge amount (g) | | | | CHMA/42 | BzMA/42 | IBMA/42 | IBMA/30 |
| Monomer (E)/charge amount (g) | | | | DAAM/5 | — | DAAM/5 | — |
| Monomer (F)/charge amount (g) | | | | GLM/5 | GLM/5 | GLM/5 | — |
| | | | Solid | | | | |
| | | | conc./ | | | | |
| | | | number | | | | |
| | Test | Cure | of times | | | | |
| Evaluation | cloth | temp. | of wash | | | | |
| Low | Ny | 170° C. × | 0.15% | 70 | 70 | 70+ | 70 |
| concentration | | 1 min | 0.23% | 90 | 90 | 90+ | 90 |
| water | | | 0.30% | 100 | 100 | 100 | 100 |
| repellency | | | | | | | |
| Durable water | Ny | 170° C. × | HL0 | 100 | 100 | 100 | 100 |
| repellency | | 1 min | HL20 | 90+ | 90+ | 90+ | 90 |
| | PET | 120° C. × | HL0 | 100 | 100 | 100 | 100 |
| | 70 d | 2 min | HL20 | 90 | 90 | 90+ | 90 |
| | PET | 100° C. × | HL0 | 100 | 100 | 100 | 100 |
| | 20 d | 2 min | HL20 | 90 | 90+ | 90+ | 90 |

| | | | | |
|---|---|---|---|---|
| Tackiness of polymer | 21 | 96 | 1 | 11 |

TABLE 3

| | | | | Com. | Com. | Com. | Com. | Com. |
|---|---|---|---|---|---|---|---|---|
| | | | | Ex. 1 | Ex. 2 | Ex. 3 | Ex. 4 | Ex. 5 |
| Monomer (A)/charge amount (g) | | | | C6SFCLA/ | C6SFCLA/ | C6SFMA150 | C6SFCLA/ | C6SFCLA/ |
| | | | | 150 | 150 | | 110 | 110 |
| Monomer (B)/charge amount (g) | | | | StA/53 | StA/100 | LA/100 | BA/42 | CA/42 |
| Monomer (C)/charge amount (g) | | | | VCI/62 | — | — | VCI/62 | VCI/62 |
| Monomer (D)/charge amount (g) | | | | — | — | — | CHMA/ | CHMA/ |
| | | | | | | | 42 | 42 |
| Monomer (E)/charge amount (g) | | | | — | — | — | DAAM/5 | DAAM/5 |
| Monomer (F)/charge amount (g) | | | | — | — | — | GLM/5 | GLM/5 |
| | | | Solid conc./ | | | | | |
| | Test | Cure | number of | | | | | |
| Evaluation | cloth | temp. | times of wash | | | | | |
| Low | Ny | 170° C. × | 0.15% | 50 | 0 | 0 | 50 | 50 |
| concentration | | 1 min | 0.23% | 70 | 50 | 0 | 70+ | 70+ |
| water | | | 0.30% | 80 | 70 | 50 | 80 | 80 |
| repellency | | | | | | | | |
| Durable | Ny | 170° C. × | HL0 | 100 | 90 | 50 | 100 | 100 |
| water | | 1 min | HL20 | 50 | 0 | 0 | 80 | 80+ |
| repellency | PET | 120° C. × | HL0 | 100 | 70 | 50 | 100 | 100 |
| | 70 d | 2 min | HL20 | 50 | 0 | 0 | 80 | 80+ |
| | PET | 100° C. × | HL0 | 80 | 0 | 50 | 100 | 100 |
| | 20 d | 2 min | HL20 | 0 | 0 | 0 | 70 | 70 |

| | | | | | |
|---|---|---|---|---|---|
| Tackiness of polymer | 528 | 3 | 5 | 1 | 1 |

| | | | | Com. | Com. | Com. | Com. |
|---|---|---|---|---|---|---|---|
| | | | | Ex. 6 | Ex. 7 | Ex. 8 | Ex. 9 |
| Monomer (A)/charge amount (g) | | | | C6SFCLA/ | C6SFCLA/ | C6SFMA/ | C6SFCLA/ |
| | | | | 110 | 110 | 110 | 150 |
| Monomer (B)/charge amount (g) | | | | StA/42 | BeA/42 | StA/42 | StA/70 |
| Monomer (C)/charge amount (g) | | | | VCI/62 | VCI/62 | VCI/62 | — |
| Monomer (D)/charge amount (g) | | | | CHMA/ | CHMA/ | CHMA/ | IBMA/ |
| | | | | 42 | 42 | 42 | 30 |
| Monomer (E)/charge amount (g) | | | | DAAM/5 | DAAM/5 | — | — |
| Monomer (F)/charge amount (g) | | | | GLM/5 | GLM/5 | GLM/5 | — |
| | | | Solid conc./ | | | | |
| | Test | Cure | number of | | | | |
| Evaluation | cloth | temp. | times of wash | | | | |
| Low | Ny | 170° C. × | 0.15% | 50 | 50 | 50 | 50 |
| concentration | | 1 min | 0.23% | 70 | 70 | 70 | 70 |
| water | | | 0.30% | 80 | 80 | 80+ | 80 |
| repellency | | | | | | | |
| Durable | Ny | 170° C. × | HL0 | 100 | 100 | 100 | 100 |
| water | | 1 min | HL20 | 80− | 80 | 80 | 50 |
| repellency | PET | 120° C. × | HL0 | 100 | 100 | 100 | 100 |
| | 70 d | 2 min | HL20 | 70+ | 80 | 80 | 50 |
| | PET | 100° C. × | HL0 | 90+ | 100 | 100 | 100 |
| | 20 d | 2 min | HL20 | 70 | 70 | 80− | 0 |

| | | | | |
|---|---|---|---|---|
| Tackiness of polymer | 20 | 5 | 230 | 2 |

### INDUSTRIAL APPLICABILITY

The fluorine-containing polymer of the present invention can be used as an active component of a treatment agent, especially a surface treatment agent, for example, a water- and oil-repellent agent, a soil resistant agent, and a soil release agent.

The embodiments of the present invention are as follows.

<1>

A fluorine-containing polymer comprising:

(a) repeating units derived from a fluorine-containing monomer having a fluoroalkyl group which is an acrylate ester monomer substituted at α-position with a monovalent organic group or a halogen atom, and

(b) repeating units derived from a fluorine-free monomer which is alkyl acrylate having an alkyl group having 6-13 carbon atoms.

<2>

The fluorine-containing polymer of <1>, wherein the fluorine-containing monomer (a) is a fluorine-containing monomer represented by the formula:

CH₂═C(—X)—C(═O)—Y—Z—Rf

wherein X is a monovalent organic group or a halogen atom.

Y is —O— or —NH—:

Z is a direct bond or a divalent organic group, and

Rf is a fluoroalkyl group having 1 to 20 carbon atoms.

<3>

The fluorine-containing polymer of <1> or <2>, wherein the fluorine-containing monomer (a) is a compound represented by the formula:

CH₂═C(—X)—C(═O)—Y—Z—Rf (I)

wherein X is a linear or branched alkyl group having 2-21 carbon atoms, a fluorine atom, a chlorine atom, a bromine atom, an iodine atom, a CFX¹X² group (where X¹ and X² are a hydrogen atom, a fluorine atom, a chlorine atom, a bromine atom or an iodine atom), a cyano group, a linear or branched fluoroalkyl group having 1-21 carbon atoms, a substituted or unsubstituted benzyl group, or a substituted or unsubstituted phenyl group;

Y is —O— or —NH—;

Z is an aliphatic group having 1-10 carbon atoms, an aromatic group or cycloaliphatic group having 6-18 carbon atoms,

a —CH₂CH₂N(R¹)SO₂— group (where R¹ is an alkyl group having 1-4 carbon atoms),
a —CH₂CH(OZ¹)CH₂— group (where Z¹ is a hydrogen atom or an acetyl group),
a —(CH₂)ₘ—SO₂—(CH₂)ₙ— group or a —(CH₂)ₘ—S—(CH₂)ₙ— group (where m is 1-10 and n is 0-10),

Rf is a linear or branched fluoroalkyl group having 1 to 20 carbon atoms,

<4>

The fluorine-containing polymer according to any one of <1> to <3>, wherein the fluorine-containing monomer (a) is alkyl acrylate which has the α-position substituted with a chlorine atom.

<5>

The fluorine-containing polymer according to any one of <1> to <4>, wherein the alkyl acrylate (b) is an alkyl acrylate represented by the formula:

CH₂=CA¹COOA²

wherein A¹ is a hydrogen atom, a methyl group or a halogen atom other than a fluorine atom (for example, a chlorine atom, a bromine atom, and an iodine atom), and
A² is an alkyl group expressed by CₙH₂ₙ₊₁ (n=6-13).
<6>

The fluorine-containing polymer of <1> to <5>, wherein the number of carbon atoms of an alkyl group are 8-13 in a fluorine-free monomer (b).

<7>

The fluorine-containing polymer of any one of <1> to <6>, wherein the fluorine-containing polymer further comprises at least one repeating unit selected from the group consisting of:

(c) repeating units derived from a halogenated olefin monomer, and
(d) repeating units derived from a fluorine-free monomer other than the monomers (b)-(c).
<8>

The fluorine-containing polymer of <7>, wherein the halogenated olefin monomer (d) is an olefin having 2-20 carbon atoms and substituted by 1-10 chlorine atoms, bromine atoms or iodine atoms.

<9>

The fluorine-containing polymer of <7> or <8>, wherein the fluorine-free monomer (d) is at least one selected from the group consisting of a fluorine-free cyclic hydrocarbon group-containing (meth)acrylate monomer (d1) and a fluorine-free crosslikable monomer (d2).

<10>

The fluorine-containing polymer of <9>, wherein the cyclic hydrocarbon group-containing acrylate ester monomer (c) is a compound represented by the formula:

CH₂═CA-C(═O)—O-Q

wherein A is a hydrogen atom, a methyl group or a halogen atom other than a fluorine atom (for example, a chlorine atom, a bromine atom, and a iodine atom), and
Q is a cyclic hydrocarbon group.
<11>

The fluorine-containing polymer of <9>, wherein the fluorine-free crosslinkable monomer (d2) is monomer having at least two reactive groups and/or carbon-carbon double bonds, and the reactive group is a hydroxyl group, an epoxy group, a chloromethyl group, a blocked isocyanate group, an amino group or a carboxyl group.

<12>

The fluorine-containing polymer of any one of <1> to <9>, wherein the amount of the acrylate ester monomer (b) is 5 to 300 parts by weight, based on 100 parts by weight of fluorine-containing monomer (a).

<13>

A surface treatment agent which comprises the fluorine-containing polymer of <1> to <12>.

<14>

The surface treatment agent of <13> which is a water- and oil-repellent agent, a soil resistant agent or a soil release agent.

<15>

The surface treatment agent of <13> or <14> which contains also an aqueous medium

<16>

A method of treating a substrate, which comprises treating the substrate with the surface treatment agent of <13>.

<17>

A substrate which is treated with the surface treatment agent of <13>.

1. A fluorine-containing polymer comprising:
(a) repeating units derived from a fluorine-containing monomer having a fluoroalkyl group which is an acrylate ester monomer substituted at α-position with a monovalent organic group or a halogen atom,
(b) repeating units derived from a fluorine-free monomer which is alkyl acrylate having an alkyl group having 6-13 carbon atoms, and
(c) repeating units derived from a fluorine-free (meth)acrylate monomer having a cyclic hydrocarbon group.

2. The fluorine-containing polymer according to claim 1, wherein the fluorine-containing monomer (a) is a compound represented by the formula:
CH₂═C(—X)—C(═O)—Y—Z—Rf (I)
wherein X is a linear or branched alkyl group having 2-21 carbon atoms, a fluorine atom, a chlorine atom, a bromine atom, an iodine atom, a CFX¹X² group (where X¹ and X² are a hydrogen atom, a fluorine atom, a chlorine atom, a bromine atom or an iodine atom), a cyano group, a linear or branched fluoroalkyl group having 1-21 carbon atoms, a substituted or unsubstituted benzyl group, or a substituted or unsubstituted phenyl group;
Y is —O— or —NH—;
Z is an aliphatic group having 1-10 carbon atoms, an aromatic group or cycloaliphatic group having 6-18 carbon atoms,
a —CH₂CH₂N(R¹)SO₂— group (where R¹ is an alkyl group having 1-4 carbon atoms),
a —CH₂CH(OZ¹)CH₂-(Ph-O)ₚ— group (where Z¹ is a hydrogen atom or an acetyl group, Ph is a phenylene group, and p is 0 or 1),
a —(CH₂)ₙ-Ph-O— group (where Ph is a phenylene group and n is 0-10)
a —(CH₂)ₘ—SO₂—(CH₂)ₙ— group or a —(CH₂)ₘ—S—(CH₂)ₙ— group (where m is 1-10 and n is 0-10),
Rf is a linear or branched fluoroalkyl group having 1 to 20 carbon atoms.

3. The fluorine-containing polymer according to claim 1, wherein the fluorine-containing monomer (a) is alkyl acrylate which has the α-position substituted with a chlorine atom.

4. The fluorine-containing polymer according to claim 2, wherein, in the fluorine-containing monomer (a), the number of carbon atoms of Rf is from 1 to 6.

5. The fluorine-containing polymer according to claim 1, wherein the alkyl acrylate (b) is an alkyl acrylate represented by the formula:
CH₂═CA¹COOA²
wherein A¹ is a hydrogen atom, a methyl group or a halogen atom other than a fluorine atom (for example, a chlorine atom, a bromine atom, and an iodine atom), and
A² is an alkyl group expressed by CₙH₂ₙ₊₁ (n=6-13).

6. The fluorine-containing polymer according to claim 1, wherein the alkyl acrylate monomer (b) is at least one selected from the group consisting of hexyl (meth)acrylate, heptyl (meth)acrylate, octyl (meth)acrylate, nonyl (meth)acrylate, decyl (meth)acrylate, undecyl (meth)acrylate, lauryl (meth)acrylate and tridecyl (meth)acrylate.

7. The fluorine-containing polymer according to claim 1, wherein the cyclic hydrocarbon group-containing acrylate ester monomer (c) is a compound represented by the formula:
CH₂═CA-C(═O)—O-Q
wherein A is a hydrogen atom, a methyl group or a halogen atom other than a fluorine atom (for example, a chlorine atom, a bromine atom, and a iodine atom), and
Q is a cyclic hydrocarbon group.

8. The fluorine-containing polymer according to claim 1, wherein the fluorine-containing polymer further comprises at least one repeating unit selected from the group consisting of:
(d) repeating units derived from a halogenated olefin monomer, and
(e) repeating units derived from a fluorine-free monomer other than the monomers (b)-(d).

9. The fluorine-containing polymer according to claim 8, wherein the halogenated olefin monomer (d) is an olefin having 2-20 carbon atoms and substituted by 1-10 chlorine atoms, bromine atoms or iodine atoms.

10. The fluorine-containing polymer according to claim 1, wherein the amount of the acrylate ester monomer (b) is 5 to 300 parts by weight and the amount of the fluorine-free acrylate monomer (c) is 0.1 to 800 parts by weight, based on 100 parts by weight of fluorine-containing monomer (a).

11. A surface treatment agent which comprises the fluorine-containing polymer according to claim 1.

12. The surface treatment agent according to claim 11 which is a water- and oil-repellent agent, a soil resistant agent or a soil release agent.

13. The surface treatment agent according to claim 11 which contains also an aqueous medium.

14. A method of treating a substrate, which comprises treating the substrate with the surface treatment agent according to claim 11.

15. A substrate which is treated with the surface treatment agent according to claim 11.
